(19) United States
(12) Patent Application Publication
(10) Pub. No.: US 2001/0038203 A1
(43) Pub. Date: Nov. 8, 2001

(54) Book

(75) Inventors: Barrie John Henderson, Woodbridge (GB); Simon Peter Couchman, Woodbridge (GB)

Correspondence Address: Clyde L. Smith, HOWELL & HAFERKAMP, L.C., Suite 1400, 7733 Forsyth Boulevard, St. Louis, MO, 63105, US

(73) Assignee: Top That Publishing plc

(21) Appl. No.: 09/870,234

(22) Filed: May 30, 2001

Related U.S. Application Data
(63) Continuation-in-part of application No. 09/512,195, filed on Feb. 24, 2000, now Pat. No. 6,247,730.

(30) Foreign Application Priority Data
Feb. 26, 1999 (GB) 9904330.9

(51) Int. Cl. B42D 3/18

(52) U.S. Cl. 281/51

(57) ABSTRACT

A book has two covers and a set of book pages contained between the covers. The covers close to form a shape which has an external appearance resembling the head of a creature. The two covers are joined to one another along a minor portion of the periphery of the covers and are connected along the remaining portion of the said periphery by a releasable fastener such that the pages of the book can be accessed by releasing the fastener and hinging open the two covers about the minor portion of the periphery.

This application is a continuation-in-part of U.S. application Ser. No. 09/512,195 filed Feb. 24, 2000 and currently pending.

### BACKGROUND OF THE INVENTION

This specification relates to a book, and also to a book construction.

### SUMMARY OF THE INVENTION

Encouraging children to read books and to become familiar with the use of books is a very laudable desideratum. The present invention is aimed at providing a new format for the printed word which is likely to appeal to children.

In accordance with the invention, there is provided a book comprising a plurality of pages, two covers, and closure means, the covers each having a periphery separating an interior portion from an exterior portion of each of the covers, each of the covers being operatively connected to the other along a minor portion of its periphery in a manner such that the covers can be pivoted between open and closed positions relative to each other, the interior portions of the covers facing each other when the covers are in the closed position, the pages being positioned where they will be sandwiched between the covers when the covers are in the closed position and where the pages can be turned when the covers are in the open position, the exterior portions of the covers being configured in the form of a head of a creature, and the closure means comprising a fastener for securing the major portion of the periphery of the covers to one another in the closed position.

In one embodiment plurality of pages of the book are permanently secured to the covers and the fastener is a zipper fastener that extends along substantially the entire major portion of the periphery of the covers. Furthermore, the periphery of the covers are generally circular in shape and the book is configured such that the major portion of the periphery of the covers together form the appearance of a mouth of the creature being represented in a manner such that the mouth is open when the covers are in the open position and such that the mouth is closed when the covers are in the closed position.

In the above, the term “creature” includes not only animate creatures such as people and animals, but also inanimate objects such as spaceships or helicopters.

Making a book which has a secondary play value as a toy means that there can be two reasons for purchasing the item; first for its educational/instructional value as a book, and secondly for its “play” value as a toy.

The two covers are hinged to one another along a portion of the periphery and can be fastened together to releasably hold the book closed by means of a releasable fastener, such as a zipper fastener, hook and loop fasteners (such as VELCRO®), buttons and buttonholes, or other suitable fasteners known in the art.

The book can be generally spherical in shape and approximately the size of a tennis ball, i.e. having an external dimension of 100 millimeters or less. The spherical shape may be a somewhat flattened sphere. It is also convenient if the book fits into the palm of a child's hand. However, the book may have larger dimensions and may form shapes other than spheres.

Appendages relevant to the particular creature being portrayed may be connected to the book covers. For example, a book with covers in the form of a fish may have fins attached to one or both of its covers, or the eyes may be covered by (or represented by) a pair of sunglasses.

The two covers of the book are preferably removably secured closed by a fastener which extends around the remaining portion of the periphery through approximately 300° of arc, with the minor portion of the circumference forming a hinge by which the two covers are joined.

The book preferably has means by which it can be attached to an external loop, such as a person's belt loop, an eye on a rucksack, or other similar objects. This attachment means may be a conventional lanyard clip, and is can be attached to a zipper slider or attached to a dedicated loop sewn onto the surface of the book.

The insides of the two covers may have means for securing the first and last pages of the book thereto, such as an adhesive, so that when the covers are opened, the pages of the book are opened.

The book may be permanently fixed inside the covers or may be removable.

The peripheral shape of the book preferably corresponds to the peripheral shape of the covers, and the size of the book is such that it can be accommodated within the covers without distorting the external shape of the covers. The pages of the book are therefore likely to be very much smaller in total volume than the volume of the covers. The pages of the book are preferably designed specifically to fit within covers of a specific book shape.

The front and back covers are preferably faced in a fabric and filled with a compressible filling such as a suitable foam.

While the principle advantages and features of the invention have been described above, the invention is further described below, by way of example, with reference to the accompanying drawings.

### BRIEF DESCRIPTION OF THE DRAWINGS

FIG. 1 is an external view of a book in accordance with the invention.

FIG. 2 is a cross-section through the book of FIG. 1.

FIG. 3 shows the book of FIG. 1 with the covers opened up ready to receive the pages of the book.

FIG. 4 shows the book of FIG. 1 with the covers completely opened up with the pages in place and ready to be read.

FIG. 5 shows the shape of the pages for use in the book of FIGS. 1-4.

FIG. 6 shows the pages of FIG. 5 fully opened in a position to be read.

FIGS. 7 and 8 show an alternative embodiment of the invention, with the covers in both their closed position (FIG. 7) and their open position (FIG. 8).

FIGS. 9-14 show a number of different embodiments of the invention.

### DETAILED DESCRIPTION OF THE INVENTION

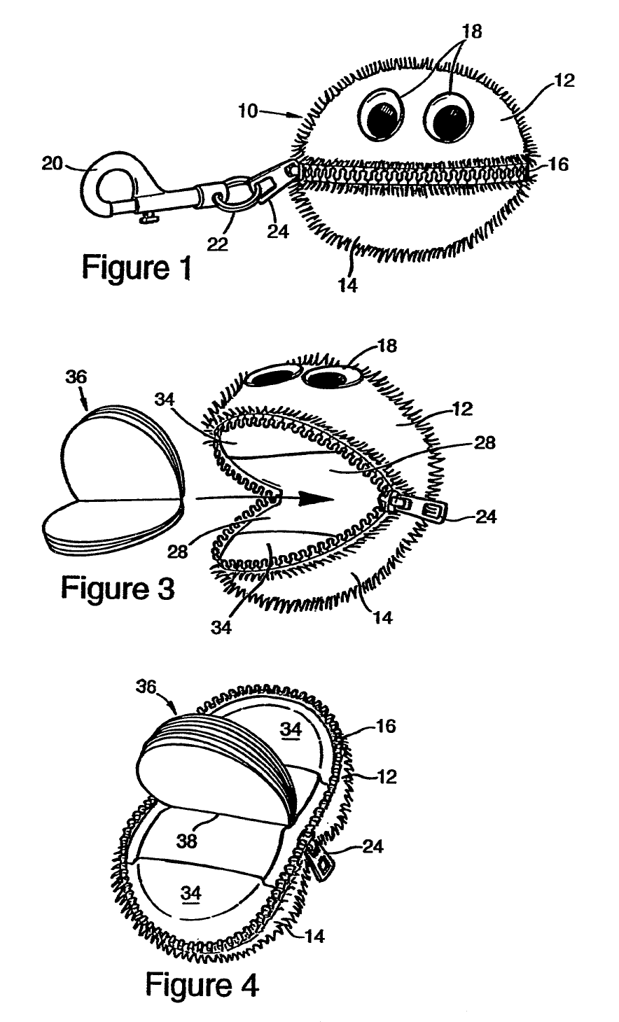

FIG. 1 shows an object generally designated 10 which is a somewhat flattened sphere. The object has two halves 12 and 14, and a zipper fastener 16 joins the two halves. Each half has a fabric cover filled with a soft compressible filling. The outer cover may be smooth or furry, and the upper half 12 carries two eyes 18 attached to the fabric in a manner conventionally known in the manufacture of soft toys. It will be seen from FIG. 1 that the zipper 16 gives the appearance of a mouth so that the object is generally animate in appearance.

A conventional lanyard clip 20 is attached by a ring 22 to the zipper slider 24. This allows the object to be clipped to a key ring, to a belt loop or to some other part of a person's clothing or personal belongings.

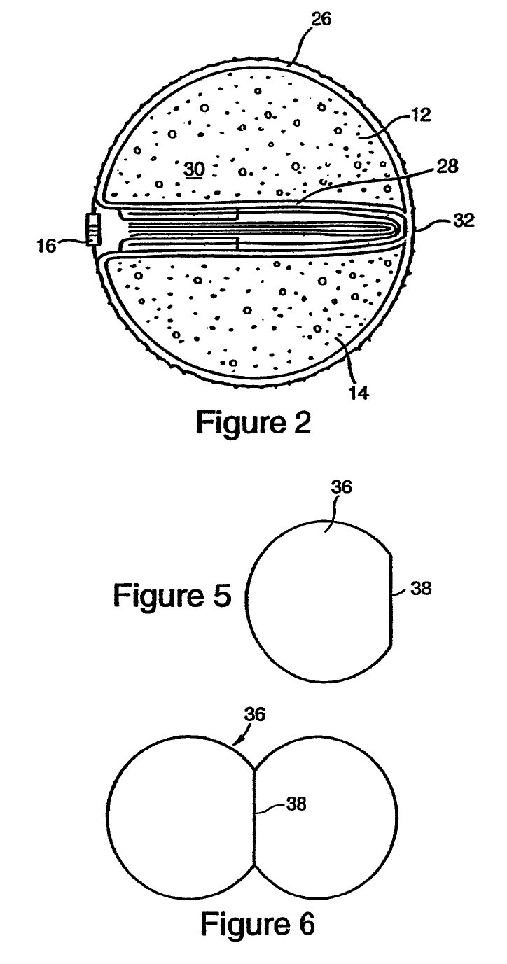

FIG. 2 shows a cross-section through the object of FIG. 1. Each half 12, 14 has an outer covering 26 of fabric, and an inner web 28. A soft compressible filling 30 is trapped in each half between the outer cover 26 and the inner web 28. At the back of the object, the outer cover 26 extends at 32 between the two halves to form a hinge.

FIG. 3 is a perspective view of the object with the zipper opened. It will be seen that the two halves of the toy open in the manner of a mouth, with the teeth of the zipper being akin to the teeth in a mouth.

Each web 28 which forms the inside of the mouth is provided with a pocket 34, and the first and last pages of a printed, book-like insert or booklet 36 can slide into these pockets, in the manner illustrated in FIG. 2 and FIG. 4, so that the halves 12 and 14 form covers for the book. The book will normally be permanently secured between the covers 12,14.

FIG. 4 shows the book opened wide, in the position where the pages of the book can easily be read.

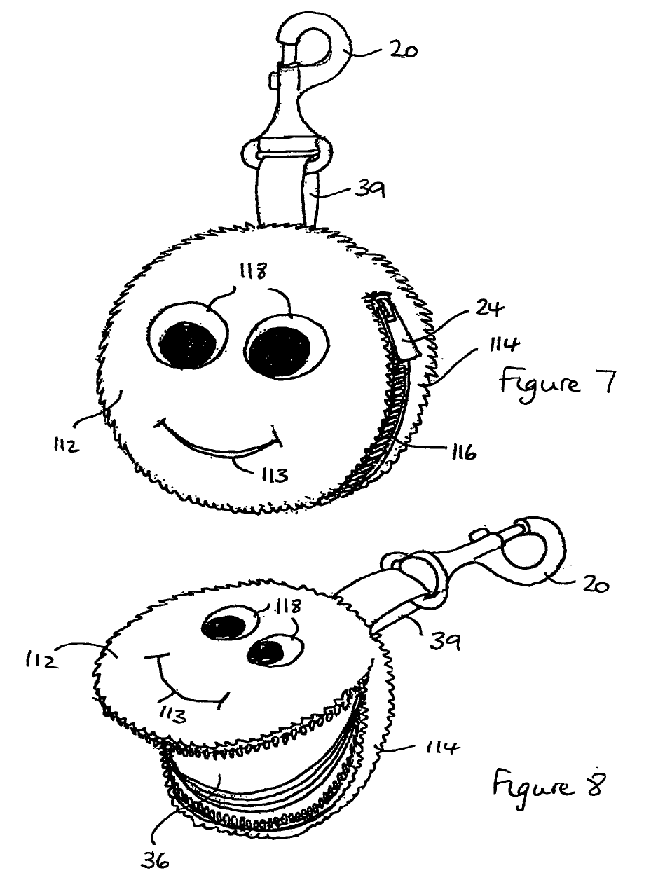

FIGS. 5 and 6 show the book or booklet (without its covers) in the closed position (FIG. 5) and in the open position (FIG. 6). It will be seen that the book has a spine 38. The pages can be stapled together by staples which lie along the spine or bound together by the use of adhesive (perfect bound). The pages each have the generally circular shape shown in FIGS. 5 and 6, with the diameter of each page being such that it will fit within the pockets 34 and thus inside the closed covers.

FIGS. 7 and 8 show an alternative embodiment of a book wherein the zipper 116 extends along the periphery of the book covers, but does not represent a mouth of the character being depicted. In this case, the character has a separate mouth 113 which is an embroidered mouth shape positioned on one of the covers 112 of the book. It should also be understood that the mouth could be formed using other suitable means known in the art such as being printed directly onto one of the covers.

To read the book, the user will unzip the zipper 16,116 to its fullest extent and open the book to the position shown in FIG. 4. The pages can then be turned over and read in a normal way.

The book is intended for children. The contents of the book will usually be suitable for reading by children. Although the book can contain printed matter, it can also be a picture book or a coloring book with pictures which can be colored by a child, or the book could even have plain pages, without any printing on them at all, so that the book could be used as a notebook. The book could also contain sticker material to form a sticker book.

The fabric cover 26 can be any suitable plain colored or patterned fabric. The fabric can be smooth, furry or hairy and, in addition to the eyes, it could have other parts attached to it.

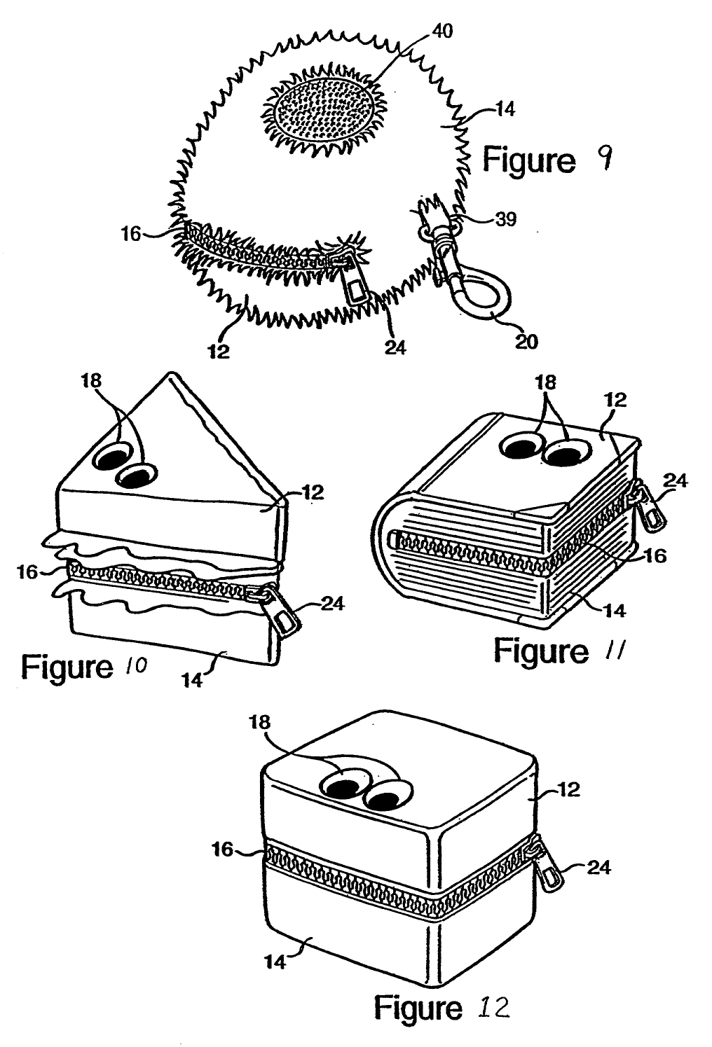

A lanyard clip 20 or similar could be attached either to the zipper slider 24 (FIG. 1), or to a separate loop sewn into the outer face of the toy, as shown, for example, at 39 in FIG. 9.

FIG. 9 shows the under side of a toy in accordance with the invention, with a patch 40 of a hook-and-loop fastener (such as a VELCRO®-type fastener) so that the toy can be placed and retained on a suitable surface which will engage with the fastener on the patch 40.

FIG. 10 shows a toy in accordance with the invention in a triangular shape, rather than circular, decorated to resemble a sandwich.

FIG. 11 shows a toy in accordance with the invention which is decorated to resemble a fat book.

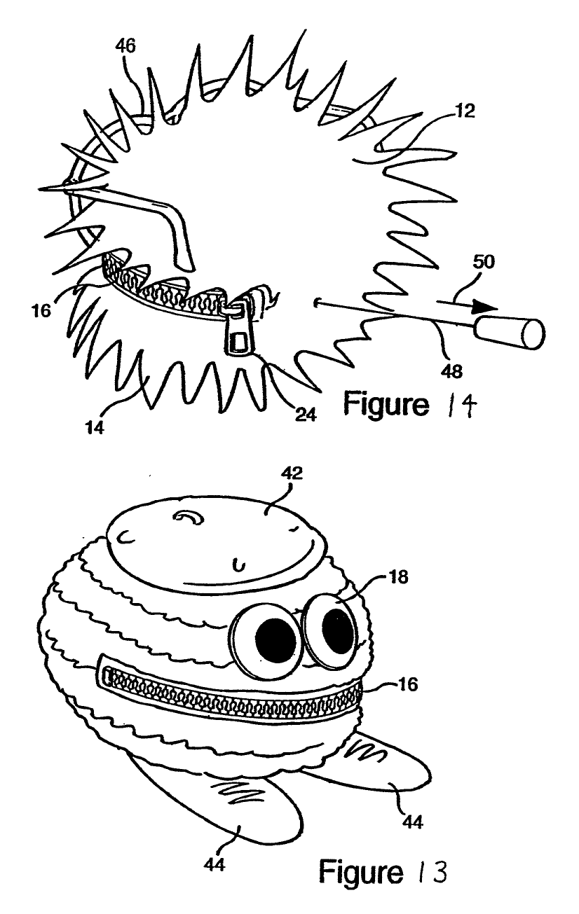

FIG. 12 shows a toy in accordance with the invention which is in the form of a square or oblong block.

FIG. 13 is a toy in accordance with the invention which is decorated with a hat 42 and feet 44 to resemble a caricature of a person-like creature.

FIG. 14 shows a toy similar to FIG. 1. However this toy has an outer surface with rough hair, and is wearing sunglasses 46. Also, one of the halves 12,14 of the toy contains an internal component which, for example, can play music or talk or vibrate or perform some other “amusing” function. This component can be operated by pulling a pull-cord 48 as indicated by an arrow 50 to either tension a clockwork spring, or to directly operate an mechanism. Alternatively (although not shown in the drawings) there may be a battery or other electrically operated device housed within one part of the toy.

It is of the essence of the invention that the toy should be appealing to children, and the decoration can therefore incorporate a wide variety of features that will appeal to children. In addition to the shapes shown, the toy could for example take the form and design of a football or of a hamburger, but an almost infinite variety of designs is possible. The zipper fastener 16 could be made with colored teeth and/or the tapes on either side of the zipper teeth could be colored, either the same color or different colors. The colors of the teeth could also vary along the length of the zipper.

Instead of a zipper, some other means may be provided for fastening the two halves of the toy together. However, a zipper fastener is particularly appropriate because of the way in which it mimics a mouth, but a flap with a VELCRO® fastener could also be used in place of a zipper.

The filling within the spaces 30 (FIG. 2) can be any material conventionally used for stuffing soft toys, including pelleted or bean-like fillings.

The exterior of the books can be manufactured so that a group of them form a set. For example they could be manufactured in the colors of a football team.

Instead of the lanyard clip 20, the book could have a wrist strap or a wrist loop to enable it to be attached to a person or another object.

Preferably the book insert 36 is not removable by the user such that the subject matter of the book may relate to the form or decoration of the covers.

A wide variety of different forms is possible, making the books attractive to children and encouraging them to read.

While the present invention has been described by reference to specific embodiments, it should be understood that modifications and variations of the invention may be constructed without departing from the scope of the invention defined by the following claims.

What is claimed:

1. A book comprising a plurality of pages, two covers, and closure means, the covers each having a generally circular periphery separating an interior portion from an exterior portion of each of the covers, each of the covers being operatively connected to the other along a minor portion of its periphery in a manner such that the covers can be pivoted between open and closed positions relative to each other, the pages being permanently secured to the covers and being positioned where they will be sandwiched between the covers when the covers are in the closed position and where the pages can be turned when the covers are in the open position, the exterior portions of the covers being configured in the form of a head of a creature, and the closure means comprising a zipper fastener extending over substantially a major portion of the periphery of the covers to releasably secure the covers to one another in the closed position.

2. The book of claim 1, wherein the covers form a generally spherical shape when the covers are in the closed position.

3. The book of claim 2, wherein the spherical shape formed by the covers when the covers are in the closed position is a flattened sphere.

4. The book of claim 1, further comprising appendages relevant to the creature being portrayed, the appendages being mounted on at least one of the covers.

5. The book of claim 1, wherein the major portion of the periphery of each of the covers extends approximately 300 degrees of an arc along the periphery of each of the covers.

6. The book of claim 1, further comprising means for attaching the book to an external loop, such as a person's belt loop or an eye on a rucksack or similar loop.

7. The book of claim 6, wherein the means for attaching the book to an external loop is a lanyard clip attached to a zipper slider.

8. The book of claim 6, wherein the means for attaching the book to an external loop is a dedicated loop sewn onto a surface of the book.

9. The book of claim 1, wherein the interior portion of the two covers have means for securing first and last pages of the plurality of pages of the book so that when the covers are in the open position, the pages of the book are opened.

10. The book of claim 9, wherein the plurality of pages are permanently attached to the covers.

11. The book of claim 1, wherein the pages of the book have a periphery that corresponds in shape to the periphery of the covers.

12. The book of claim 1, wherein the thickness of the combined size of the pages of the book is such that the pages can be accommodated between the covers when the covers are in the closed position without distorting the shape of the exterior portions of the covers.

13. The book of claim 1, wherein the volume of the pages of the book is very much smaller in total than the volume of the covers.

14. The book of claim 1, wherein the covers are faced in a fabric and filled with a compressible filling.

15. The book of claim 1, wherein the pages of the book are completely hidden when the covers are in the closed position.

16. A book comprising a plurality of pages, two covers, and closure means, the covers each having a generally circular periphery separating an interior portion from an exterior portion of each of the covers, each of the covers being operatively connected to the other along a minor portion of its periphery in a manner such that the covers can be pivoted between open and closed positions relative to each other, the pages being permanently secured to the covers and being positioned where they will be sandwiched between the covers when the covers are in the closed position and where the pages can be turned when the covers are in the open position, the exterior portions of the covers being configured in the form of a head of a creature, and the closure means comprising a VELCRO® fastener extending over substantially a major portion of the periphery of the covers to releasably secure the covers to one another in the closed position.

17. A book comprising a plurality of pages and two covers, the covers each having a periphery separating an interior portion from an exterior portion of each of the covers, each of the covers being operatively connected to the other along a minor portion of its periphery in a manner such that the covers can be pivoted between open and closed positions relative to each other, the pages being positioned where they will be sandwiched between the covers when the covers are in the closed position and where the pages can be turned when the covers are in the open position, the exterior portions of the covers being configured in a form of a head of a creature, each of the covers having a volume that is substantially the same as the volume of the other of each of the covers such that each of the covers forms approximately one half of the head of the creature.

18. The book of claim 17, wherein the periphery of each of the covers consists essentially of the minor portion and a major portion of the periphery of each of the covers, the book further comprising a releasable fastener, the fastener extending along substantially all of the major portion of the periphery of each of the covers where it can releasably hold the covers in the closed position.

19. The book of claim 17, wherein the pages have a shape similar to the periphery of the covers.

20. The book of claim 17, wherein the pages of the book are permanently attached to the covers of the book.
